(19) United States
(12) Patent Application Publication
(10) Pub. No.: US 2012/0162216 A1
(43) Pub. Date: Jun. 28, 2012

(54) CYLINDRICAL THREE-DIMENSIONAL IMAGE DISPLAY APPARATUS AND METHOD

(75) Inventors: Do-Hyung KIM, Daejeon (KR); Ji-Hyung LEE, Daejeon (KR); Bon-Ki KOO, Daejeon (KR)

(73) Assignee: Electronics and Telecommunications Research Institute, Daejeon-city (KR)

(21) Appl. No.: 13/334,610

(22) Filed: Dec. 22, 2011

(30) Foreign Application Priority Data
Dec. 22, 2010 (KR) 10-2010-0132876
Jun. 14, 2011 (KR) 10-2011-0057629

(51) Int. Cl. G06T 15/00

(52) U.S. Cl. 345/419

(57) ABSTRACT

The present invention provides a cylindrical three-dimensional (3D) image display apparatus and method. The cylindrical 3D image display apparatus includes a spiral screen unit configured such that a plurality of individual screens, each being spirally formed, form a shape of a cylinder, and such that the spiral screen unit display an image on the cylinder. A 3D image control unit is configured to display a 3D image by controlling transparency of each of the plurality of individual screens, based on a display sequence of slice images of the 3D image projected from above or below the cylinder.

### CROSS REFERENCE TO RELATED APPLICATIONS

This application claims the benefit of Korean Patent Application Nos. 10-2010-0132876 filed on Dec. 22, 2010 and 10-2011-0057629 filed on Jun. 14, 2011, which are hereby incorporated by reference in their entirety into this application.

### BACKGROUND OF THE INVENTION

1. Technical Field

The present invention relates generally to a cylindrical three-dimensional (3D) image display apparatus and method and, more particularly, to a cylindrical 3D image display apparatus and method, which display a 3D image by controlling the electronic transparency of individual spiral screens.

2. Description of the Related Art

Generally, there are various methods of displaying 3D images in real space. In particular, 3D image display methods using binocular disparity, a one-dimensional (1D) straight line or a two-dimensional (2D) plane that is moving fast, a plasma projection scheme, a hologram, etc. have been mainly used to display 3D images.

First, the 3D image display method using binocular disparity is a scheme in which different images are projected on the left and right eyes to impart the sensation of a stereoscopic effect, and which displays an image on a screen in the form of 2D coordinates.

In detail, 3D images are displayed using various types of glasses-based schemes, for example, an anaglyph glasses scheme that displays images required for both eyes on a display surface and provides different images by applying lenses having different colors to the two eyes, a Liquid Crystal Display (LCD) shutter glasses scheme in which glasses being worn by a user cause images to selectively pass therethrough according to time, or a polarizing filter glasses scheme in which glasses to which a polarizing filter is applied cause images to selectively pass therethrough. Representative non-glasses-based schemes include a lenticular scheme that displays all the images required for both eyes on a display surface and that uses a lens, or a parallax barrier scheme that uses an optical bather on a slit. Further, mount-type schemes include a head-mounted display, which is implemented to provide a separate display for projecting different images in front of the two eyes. Such a scheme is problematic in that 3D images can be viewed only from a preset location, and a separate instrument must be worn for each different technical scheme.

Next, the 3D image display method using a 1D straight line or a 2D surface that is moving faster is implemented such that slices constituting a 3D image are projected on a rapidly vibrating or rotating screen, and the 3D image is displayed due to an afterimage effect. As this scheme, there is a scheme that projects a 2D or 3D stereoscopic image by vibrating or rotating an image projected in one-dimension in a manner opposite that of a line scanner. For example, a 2D display such as an LCD for displaying an image is rotated or, alternatively, a 2D screen is rotated, and then an image is projected on the screen. According to the form of the display or the screen that is rotating in this way, a 3D stereoscopic display may occasionally be implemented in a spherical shape or a cylindrical shape. However, this scheme is problematic in that in order to cause fast vibration or rotation, a mechanical device such as a motor must be used, and the use of such a mechanical device may result in noise and oscillations and also result in frequent troubles.

Next, the 3D image display method using a plasma projection scheme is intended to implement a 3D image by directly locating plasma, which emits light, in space. Such a plasma projection scheme is problematic in that it has limited colors, low resolution and low play resolution, and in that when plasma that emits light is directly viewed with the naked eye, damage to the optic nerve may occur.

Finally, the 3D image display method using a hologram is a scheme for recording all light interference and reproducing the recorded light interference. Such a scheme using a hologram is problematic in that extensive storage space is required.

Therefore, 3D image display technology capable of solving the above problems is required.

### SUMMARY OF THE INVENTION

Accordingly, the present invention has been made keeping in mind the above problems occurring in the prior art, and an object of the present invention is to provide a cylindrical 3D image display apparatus and method, which can display 3D images in real space without using a separate mechanical device that causes rotation to display 3D images.

In accordance with an aspect of the present invention to accomplish the above object, there is provided a cylindrical three-dimensional (3D) image display apparatus, including a spiral screen unit composed of a plurality of individual screens, the plurality of individual screen forming a shape of a cylinder, wherein each of the plurality of individual screens is spirally formed and a 3D image is displayed on the spiral screen unit; and a 3D image control unit configured to display a 3D image by controlling transparency of each of the plurality of individual screens, based on a display sequence of slice images of the 3D image.

Preferably, the 3D image may be projected from above or below the cylinder.

Preferably, the 3D image control unit may control the plurality of individual screens such that each of the individual screens sequentially goes into an opaque state.

Preferably, the 3D image control unit may generate a synchronization signal required to synchronize time points at which each of the plurality of individual screens goes into the opaque state with time points at which each of the slice images to be displayed on the individual screens going into the opaque state is projected.

Preferably, the apparatus may further include a transparency control unit for controlling the transparency of each of the plurality of individual screens, based on the synchronization signal.

Preferably, the transparency control unit may determine a relevant individual screen that is to go into the opaque state among the plurality of individual screens, based on the synchronization signal.

Preferably, the apparatus may further include an image projection unit for projecting a relevant slice image at a time point at which the relevant individual screen goes into the opaque state, based on the synchronization signal.

Preferably, the apparatus may further include an image management unit for managing playing of the 3D image and storing the 3D image.

In accordance with another aspect of the present invention to accomplish the above object, there is provided a cylindrical three-dimensional (3D) image display method, including determining activation time points required to control transparency of each of a plurality of individual screens, each being spirally formed, based on a display sequence of slice images of a 3D image that is to be displayed on the plurality of individual screens; controlling each of the plurality of individual screens so that each of the individual screens goes into an opaque state based on the activation time points; and synchronizing time points at which each of the individual screens goes into the opaque state with time points at which each of the slice images to be displayed on the individual screens going into the opaque state is projected, then displaying the 3D image.

Preferably, the controlling so that each the individual screens goes into the opaque state may include controlling the individual screens so that the individual screens sequentially go into the opaque state.

Preferably, the controlling so that the individual screens go into the opaque state may include controlling the individual screens so that if any one of the individual screens goes into the opaque state, remaining individual screens go into a transparent state.

Preferably, the relevant slice images projected on the remaining individual screens that are in the transparent state may pass through the remaining individual screens and may not be displayed thereon.

Preferably, the plurality of individual screens may form a shape of a cylinder.

Preferably, the 3D image may be projected from above or below the cylinder.

According to an embodiment of the present invention, a plurality of individual screens are rapidly switched such that the individual screens sequentially go into an opaque state, but a 3D image is displayed by synchronizing the time points at which each of the plurality of individual screens are activated to the opaque state with the time points at which each of slice images are displayed. Accordingly, the present invention can provide a 3D image that can be viewed from 360° viewing angle in real space without requiring existing conventionally used mechanical device such as a motor that causes rotation or vibration to display 3D images. Therefore, a user does not need to wear an additional instrument such as 3D glasses and can view 3D images without being subject to the spatial restrictions of the viewing location.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram schematically showing a cylindrical 3D image display apparatus according to an embodiment of the present invention;

FIG. 2 is a diagram schematically showing a spiral screen unit according to an embodiment of the present invention;

FIG. 3 is a diagram schematically showing an example of the individual screen of the spiral screen unit of FIG. 2;

FIG. 4 is a diagram showing an example of a 3D image desired to be displayed on the spiral screen unit of FIG. 2;

FIG. 5 is a diagram showing an example of a slice image of the 3D image of FIG. 4;

FIG. 6 is a diagram showing an example in which the locations of the image projection unit and the spiral screen unit of FIG. 1 are set;

FIG. 7 is a diagram showing an example in which a 3D image is displayed on the spiral screen unit of FIG. 2; and

FIG. 8 is a flowchart showing a method of displaying a 3D image using the cylindrical 3D image display apparatus according to an embodiment of the present invention.

### DESCRIPTION OF THE PREFERRED EMBODIMENTS

Reference now should be made to the drawings, in which the same reference numerals are used throughout the different drawings to designate the same or similar components.

The present invention will be described in detail below with reference to the accompanying drawings. In the following description, redundant descriptions and detailed descriptions of known functions and elements that may unnecessarily make the gist of the present invention obscure will be omitted. Embodiments of the present invention are provided to fully describe the present invention to those having ordinary knowledge in the art to which the present invention pertains. Accordingly, in the drawings, the shapes and sizes of elements may be exaggerated for the sake of clearer description.

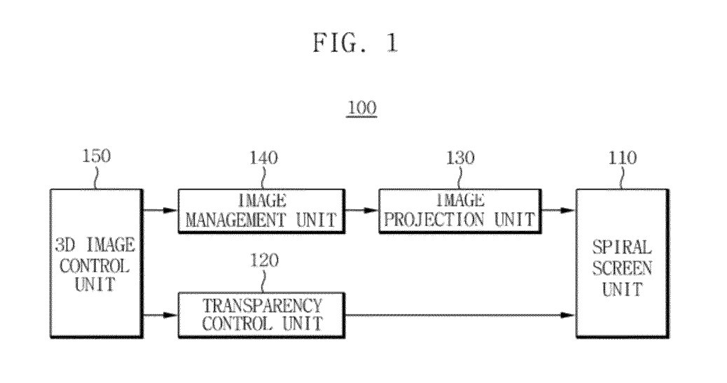

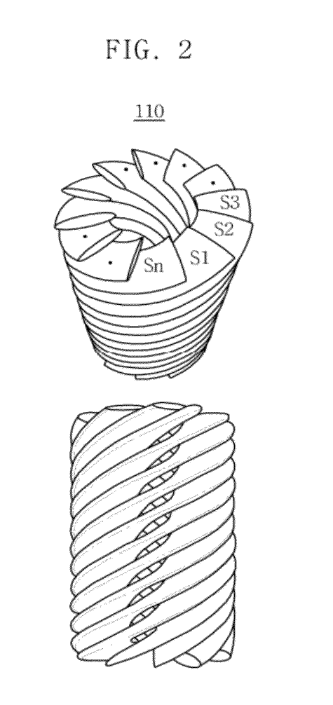

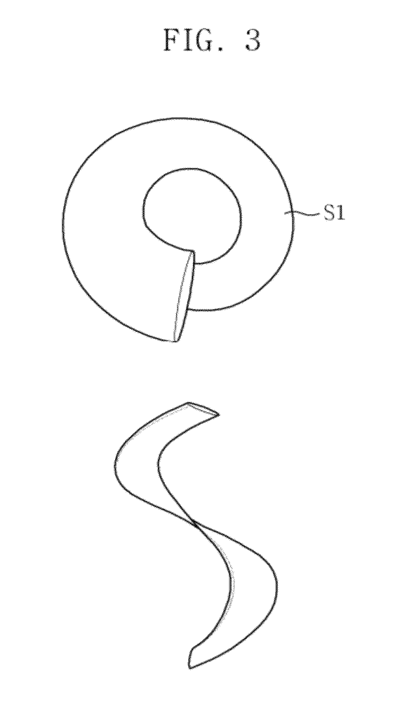

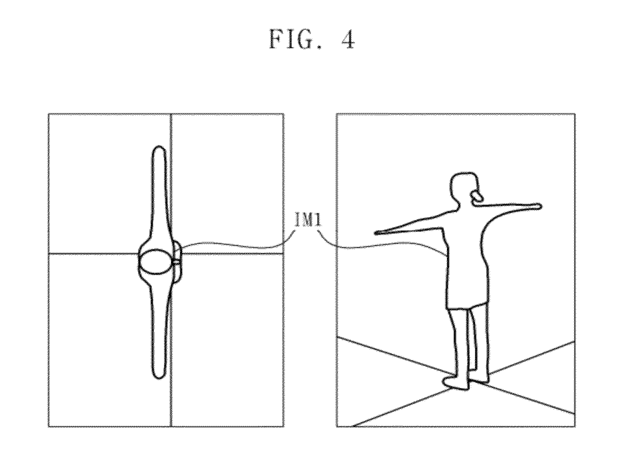

FIG. 1 is a diagram schematically showing a cylindrical 3D image display apparatus according to an embodiment of the present invention. FIG. 2 is a diagram schematically showing a spiral screen unit according to an embodiment of the present invention. FIG. 3 is a diagram schematically showing an example of the individual screen of the spiral screen unit of FIG. 2. FIG. 4 is a diagram showing an example of a 3D image desired to be displayed on the spiral screen unit of FIG. 2.

As shown in FIG. 1, a cylindrical 3D image display apparatus 100 according to an embodiment of the present invention includes a spiral screen unit 110, a transparency control unit 120, an image projection unit 130, an image management unit 140, and a 3D image control unit 150.

As shown in FIG. 2, the spiral screen unit 110 is configured such that a plurality of individual screens S1 to Sn, which are respectively spirally formed and are spaced apart from one another by a predetermined interval, form the shape of a cylinder. The spiral screen unit 110 displays an image thereon.

In this case, all individual screens S1 to Sn are formed in the same spiral shape, as shown in FIG. 3.

The individual screens S1 to Sn go into a transparent state or an opaque state under the electrical control of the transparency control unit 120. That is, of the plurality of individual screens S1 to Sn, only an individual screen, on which the slice image of a 3D image is to be projected, goes into an opaque state, and the remaining individual screens go into a transparent state. In this way, when the plurality of individual screens S1 to Sn sequentially and rapidly go into the opaque state, corresponding slice images are projected on the screens, thus allowing a user to perceive the entire 3D image.

In an embodiment of the present invention, when a relevant individual spiral screen goes into a transparent state, a relevant slice image of a 3D image projected by the image projection unit 130 passes through the transparent individual spiral screen, thus preventing the slice image from being displayed on the transparent individual spiral screen.

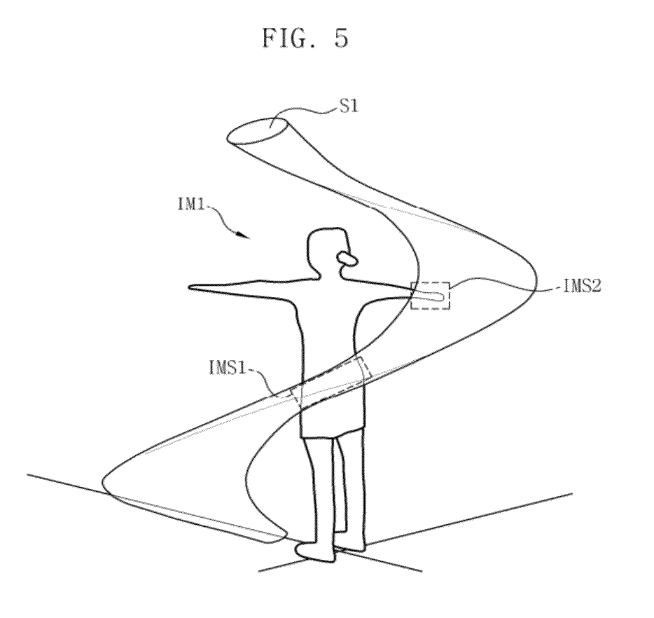

However, when an individual screen is activated to the opaque state, the relevant slice image of the 3D image is displayed on the individual screen. For example, if it is assumed that it is the turn of the individual screen S1 among the plurality of individual screens S1 to Sn to be activated to the opaque state, and an entire 3D image IM1 desired to be displayed is given as shown in FIG. 4, only slice images IMS1 and IMS2 of the entire 3D image IM1, which must be displayed on the individual screen S1, are projected on the individual screen S1, as shown in FIG. 5.

Referring back to FIG. 1, the transparency control unit 120 receives a synchronization signal from the 3D image control unit 150. The transparency control unit 120 controls the plurality of individual screens S1 to Sn such that each of the individual screens S1 to Sn goes into the transparent or opaque state. The synchronization signal according to an embodiment of the present invention is configured to synchronize the time points at which the individual screens go into the opaque state with the time points at which corresponding slice images are projected, and may include information about relevant individual screens desired to be controlled to go into the opaque state, the time points at which the individual screens are controlled to go into the opaque state, and the time points at which relevant slice images are projected, etc.

In detail, the transparency control unit 120 determines an individual screen, which is to be activated to the opaque state, among the plurality of individual screens S1 to Sn from using the synchronization signal. That is, the transparency control unit 120 determines an individual screen S1, which is to be firstly activated to the opaque state, among the plurality of individual screens S1 to Sn using the synchronization signal. Further, the transparency control unit 120 generates an electrical signal so that the individual screen S1 goes into the opaque state, and transmits the electrical signal to the spiral screen unit 110. Furthermore, the transparency control unit 120 determines an individual screen S2, which is to be subsequently activated to the opaque state. The transparency control unit 120 generates an electrical signal so that the individual screen S2 goes into the opaque state, and transmits the electrical signal to the spiral screen unit 110. Using the same method, the transparency control unit 120 generates electrical signals so that the remaining individual screens S3 to Sn go into the opaque state, and transmits the electrical signals to the spiral screen unit 110.

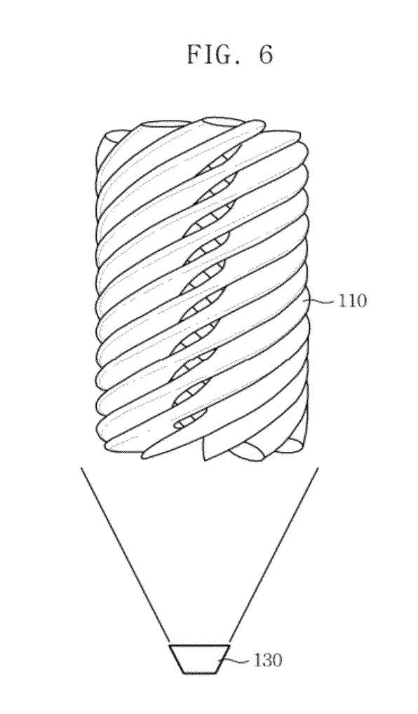

The image projection unit 130 is disposed above or below the cylinder; that is, above or below the plurality of individual screens S1 to Sn forming the spiral screen unit 110. The image projection unit 130 is configured to project a 3D image, and an example thereof is shown in FIG. 6. Such an image projection unit 130 projects a relevant slice image on one of the plurality of individual screens using the synchronization signal.

For example, when the individual screen S1 among the plurality of individual screens S1 to Sn is activated to the opaque state, the image projection unit 130 detects the individual screen S1 using the synchronization signal, and projects a relevant slice image on the individual screen S1 at the time point at which the individual screen S1 goes into the opaque state.

Referring back to FIG. 1, the image management unit 140 manages the playing of the entire 3D image desired to be displayed on the spiral screen unit 110, and stores the entire 3D image. That is, the image management unit 140 transmits relevant slice images to the image projection unit 130 on the basis of the synchronization signal.

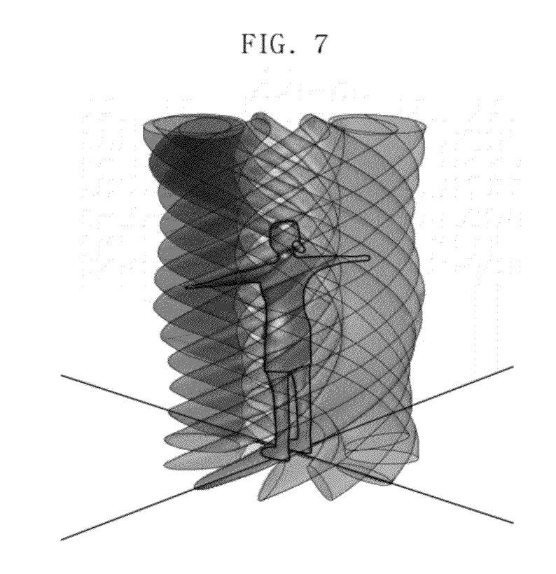

The 3D image control unit 150 determines activation time points at which the individual screens S1 to Sn are to be activated to the opaque state on the basis of the display sequence of the slice images of the 3D image. The 3D image control unit 150 generates the synchronization signal required to perform synchronization so that a relevant slice image is projected onto any one of the plurality of individual screens S1 to Sn at the time point at which the relevant individual screen goes into the opaque state on the basis of the determined activation time points. Further, the 3D image control unit 150 transfers the generated synchronization signal to the transparency control unit 120 and the image projection unit 130, so that corresponding slice images are projected at the time points at which the plurality of individual screens go into the opaque state. An example of the 3D image displayed on the plurality of individual screens as a result of the projection is shown in FIG. 7.

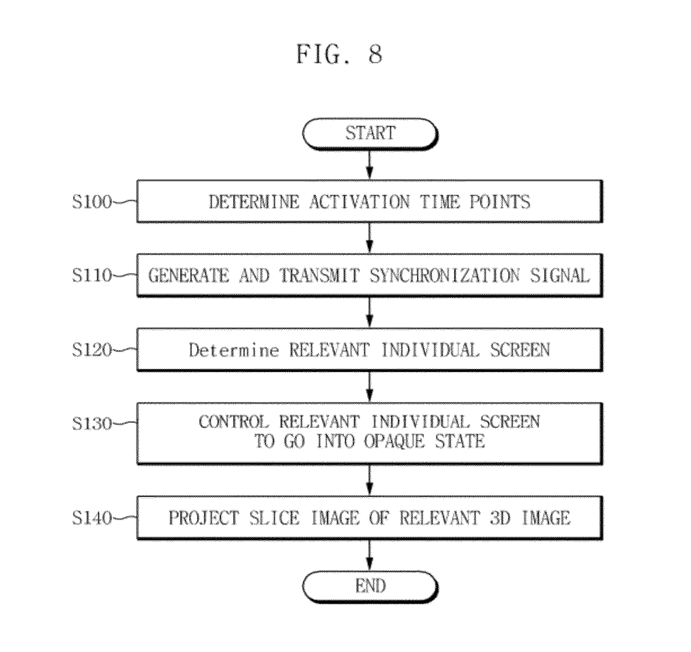

FIG. 8 is a flowchart showing a method of displaying 3D images using the cylindrical 3D image display apparatus according to an embodiment of the present invention.

As shown in FIG. 8, the 3D image control unit 150 of the cylindrical 3D image display apparatus 100 according to the embodiment of the present invention determines activation time points at which each of the plurality of individual screens is to be activated to the opaque state on the basis of the display sequence of the slice images of a 3D image desired to be displayed on the spiral screen unit 110 at step S100. The 3D image control unit 150 generates a synchronization signal required to perform synchronization so that a relevant slice image is projected on one of the individual screens S1 to Sn at the time point at which the individual screen goes into the opaque state on the basis of the determined activation time points at step S110. Further, at step S110, the 3D image control unit 150 transmits the synchronization signal both to the transparency control unit 120 and to the image projection unit 130.

The transparency control unit 120 determines a relevant individual screen, which is to be activated to the opaque state, from the plurality of individual screens using the synchronization signal at step S120. The transparency control unit 120 generates an electrical signal required to control the relevant individual screen so that the relevant individual screen goes into the opaque state, and transmits the electrical signal to the spiral screen unit 110 at step S130.

At the same time, the image projection unit 130 detects the relevant individual screen, which is to be activated to the opaque state, using the synchronization signal, and projects a relevant slice image of the 3D image on the relevant individual screen at the time point at which the individual screen goes into the opaque state in response to the electrical signal at step S140.

As described above, in the embodiment of the present invention, a plurality of individual screens are rapidly switched such that the individual screens sequentially go into the opaque state, but a 3D image is displayed by synchronizing the time points at which the plurality of individual screens are activated to the opaque state with the time points at which slice images of the 3D image are projected. Accordingly, the present invention can provide 360 degree viewing angle of a 3D image in real space without requiring an existing mechanical device such as a motor that causes rotation or vibration to display 3D images. Therefore, a user does not need to wear an additional instrument such as 3D glasses and can view 3D images without being subject to the spatial restrictions of the viewing location.

As described above, optimal embodiments of the present invention have been disclosed in the drawings and the present specification. In this case, although specific terms have been used, those terms are merely intended to describe the present invention and are not intended to limit the meanings and the scope of the present invention as disclosed in the accompanying claims. Therefore, those skilled in the art will appreciate that various modifications and other equivalent embodiments are also possible given the above description. Therefore, the technical scope of the present invention should be defined by the technical spirit of the accompanying claims.

What is claimed is:

1. A cylindrical three-dimensional (3D) image display apparatus, comprising:
a spiral screen unit composed of a plurality of individual screens, the plurality of individual screen forming a shape of a cylinder, wherein each of the plurality of individual screens is spirally formed and a 3D image is displayed on the spiral screen unit; and
a 3D image control unit configured to display a 3D image by controlling transparency of each of the plurality of individual screens, based on a display sequence of slice images of the 3D image.

2. The apparatus of claim 1, wherein the 3D image control unit controls the plurality of individual screens such that each of the individual screens sequentially goes into an opaque state.

3. The apparatus of claim 2, wherein the 3D image control unit generates a synchronization signal required to synchronize time points at which each of the plurality of individual screens goes into the opaque state with time points at which each of the slice images to be displayed on the individual screens going into the opaque state is projected.

4. The apparatus of claim 3, further comprising a transparency control unit for controlling the transparency of each of the plurality of individual screens, based on the synchronization signal.

5. The apparatus of claim 4, wherein the transparency control unit determines a relevant individual screen that is to go into the opaque state among the plurality of individual screens, based on the synchronization signal.

6. The apparatus of claim 5, further comprising an image projection unit for projecting a relevant slice image at a time point at which the relevant individual screen goes into the opaque state, based on the synchronization signal.

7. The apparatus of claim 1, further comprising an image management unit for managing playing of the 3D image and storing the 3D image.

8. A cylindrical three-dimensional (3D) image display method, comprising:
determining activation time points required to control transparency of each of a plurality of individual screens, each being spirally formed, based on a display sequence of slice images of a 3D image that is to be displayed on the plurality of individual screens;
controlling each of the plurality of individual screens so that each of the individual screens goes into an opaque state, based on the activation time points; and
synchronizing time points at which each of the individual screens goes into the opaque state with time points at which each of the slice images to be displayed on each of the individual screens going into the opaque state is projected, then displaying the 3D image.

9. The method of claim 8, wherein the controlling each of the plurality of individual screens comprises controlling each of the plurality of the individual screens so that each of the individual screens sequentially goes into the opaque state.

10. The method of claim 8, wherein the controlling each of the plurality of individual screens comprises controlling each of the individual screens so that, if any one of the individual screens goes into the opaque state, remaining individual screens go into a transparent state.

11. The method of claim 10, wherein relevant slice images projected on the remaining individual screens, which are in the transparent state, pass through the remaining individual screens and are not displayed thereon.

12. The method of claim 8, wherein the plurality of individual screens forms a shape of a cylinder.

13. The method of claim 12, wherein the 3D image is projected from above or below the cylinder.
